(19) United States
(12) Patent Application Publication
(10) Pub. No.: US 2020/0085275 A1
(43) Pub. Date: Mar. 19, 2020

(54) INTELLIGENT DISHWASHER AND METHOD FOR CONTROLLING THE SAME

(71) Applicant: LG ELECTRONICS INC., Seoul (KR)

(72) Inventor: Hyosung LEE, Seoul (KR)

(73) Assignee: LG ELECTRONICS INC., Seoul (KR)

(21) Appl. No.: 16/689,950

(22) Filed: Nov. 20, 2019

(30) Foreign Application Priority Data
Sep. 2, 2019 (KR) 10-2019-0108329

(51) Int. Cl. A47L 15/00; A47L 15/42; A47L 15/46; G05B 13/02

(52) U.S. Cl. CPC A47L 15/0021; A47L 15/0063; G05B 13/027; A47L 15/46; A47L 15/4295

(57) ABSTRACT

An intelligent dish washer and its control method are disclosed. An intelligent dish washer according to one embodiment of the present disclosure includes a transceiver for receiving cooking information about cooking from at least one of plurality of external devices; a processor configured to: receive the cooking information from the communication unit; learn dish washing information to wash a dish used for cooking corresponding to the cooking information; and determine a washing mode corresponding to the dish based on the learned dish washing information.

The intelligent dish washer according to the present disclosure may be associated with an artificial intelligence module, a drone (UAV), a robot, an AR device, a VR device, a device related to 5G service, etc.

### CROSS-REFERENCE TO RELATED APPLICATION

Pursuant to 35 U.S.C. § 119(a), this application claims the benefit of earlier filing date and right of priority to Korean Patent Application No. 10-2019-0108329, filed on Sep. 2, 2019, the contents of which are all hereby incorporated by reference herein in its entirety.

### BACKGROUND OF THE INVENTION

### Field of the Invention

The present disclosure relates to an intelligent dish washer and its control method, more specifically to an intelligent dish washer and its control method for analyzing a user cooking pattern and a container and learning the analyzed results and then performing washing in an optimal washing mode.

### Related Art

A general dish washer is a device that automatically washes a dish by spraying washing-water toward a dish placed in a washing chamber to remove foreign substances such as food residues on the surface of the dish and to rinse or dry the dish.

Such a dish washer generally performs a washing step of spraying a detergent-dissolved washing-water to a dish to wash foreign substances attached to the dish, and a rinsing step of removing excess foreign substances and detergent by spraying fresh water thereto after washing, and a drying step for drying the dish.

Further, in recent years, a method of heating the washing-water or the rinsing water in the washing step or the rinsing step may be used to further increase the washing effect.

A typical dish washer has at least one spray arm, and at least one or more racks on which dishes are mounted inside one washing room. In particular, in recent years, the upper rack and the lower rack may be provided in multiple layers inside the washing chamber. Upper and lower spray arms for washing-water spray may be disposed for the upper and lower racks respectively.

In one example, the user checks contaminants on the dish to wash the dishes using a conventional dish washer. A washing mode was set according to the type of contaminants. This causes the dish washer user to be inconvenient because this requires a lot of time and effort.

### SUMMARY OF THE INVENTION

The present disclosure aims to address the aforementioned needs and/or problems.

Further, a purpose of the present disclosure is to provide an intelligent dish washer and its control method for analyzing a user cooking pattern and a container and learning the analyzed results and then performing washing in an optimal washing mode.

One aspect of the present disclosure provides an intelligent dish washer including: a transceiver for receiving cooking information about cooking from at least one of plurality of external devices; a processor configured to: receive the cooking information from the communication unit; learn dish washing information to wash a dish used for cooking corresponding to the cooking information; and determine a washing mode corresponding to the dish based on the learned dish washing information.

In one implementation of the dish washer, the external devices include at least one of a cooking home device in a kitchen, a mobile device used by a user, a camera in a kitchen, or a refrigerator.

In one implementation of the dish washer, the cooking information includes at least one of: first food information about food being cooked by the cooking home device; recipe information collected based on a recipe retrieved from the mobile device; second food information about food being cooked by a gas range or a cooktop and collected from the camera installed in the kitchen; cooking material information about a cooking material used for cooking among cooking materials stored in the refrigerator; the user information; or dish shape information.

In one implementation of the dish washer, the processor is configured to: extract feature values from the cooking information obtained from the external device; input the feature values into an artificial neural network (ANN) classifier trained to distinguish a washing state of the dish; and determine the washing mode according to the washing state of the dish based on an output of the artificial neural network classifier.

In one implementation of the dish washer, the feature values are used to determine the washing mode according to the washing state of the dish.

In one implementation of the dish washer, the processor is configured to: receive, from a network, Downlink Control Information (DCI) used to schedule transmission of the cooking information obtained from the external device; and transmit the cooking information to the network based on the DCI.

In one implementation of the dish washer, the processor is configured to: perform an initial connection procedure with the network based on Synchronization signal block (SSB); and transmit the cooking information to the network on PUSCH, wherein the SSB and DM-RS of the PUSCH are quasi-co-located (QCLed) for QCL type D.

In one implementation of the dish washer, the processor is configured to: control the transceiver to send the cooking information to an AI processor included in the network; and control the transceiver to receive AI processed information from the AI processor, wherein the AI processed information includes information for setting one of washing modes according to a washing state for the dish based on the cooking information.

One aspect of the present disclosure provides a method for controlling an intelligent dish washer, the method including: obtaining cooking information from a plurality of external devices; determining a washing state of a dish based on the obtained cooking information; setting a washing mode based on the determined washing state of dish; and washing the dish according to the set washing mode.

In one implementation of the method, determining the washing state of the dish includes: extracting feature values from the cooking information obtained from the external device; inputting the feature values to an artificial neural network (ANN) classifier trained to distinguish a washing state of the dish; and determining the washing mode in accordance with the washing state of the dish based on an output of the artificial neural network classifier.

In one implementation of the method, the feature values are used to determine the washing mode according to the washing state of the dish.

In one implementation of the method, the external devices include at least one of a cooking home device in a kitchen, a mobile device used by a user, a camera in a kitchen, or a refrigerator.

In one implementation of the method, the cooking information includes at least one of: first food information about food being cooked by the cooking home device; recipe information collected based on a recipe retrieved from the mobile device; second food information about food being cooked by a gas range or a cooktop and collected from the camera installed in the kitchen; cooking material information about a cooking material used for cooking among cooking materials stored in the refrigerator; the user information; or dish shape information.

In one implementation of the method, the method further includes: receiving, from a network, Downlink Control Information (DCI) used to schedule transmission of the cooking information obtained from the external device; and transmitting the cooking information to the network based on the DCI.

In one implementation of the method, the method further includes: performing an initial connection procedure with the network based on Synchronization signal block (SSB); and transmitting the cooking information to the network on PUSCH, wherein the SSB and DM-RS of the PUSCH are quasi-co-located (QCLed) for QCL type D.

In one implementation of the method, the method further includes: controlling a transceiver to send the cooking information to an AI processor included in the network; and controlling the transceiver to receive AI processed information from the AI processor, wherein the AI processed information includes information for setting one of washing modes according to a washing state for the dish based on the cooking information.

The effects of the intelligent dish washer and its control method according to one embodiment of the present disclosure are as follows.

Further, the present disclosure may provide the ability to wash at optimum temperature and spray power by predicting foods in containers based on data collected from the user cooking device.

Further, the present disclosure may be able to derive the optimal spraying force by predicting the water temperature at which the oil of the food on the dish is well decomposed and the sticking degree of the food.

Further, the present disclosure may be able to provide detailed user-customized washing functions by collecting and learning additional user manipulation information after automatic washing.

Further, the present disclosure may provide more sophisticated user-customized washing functions by collecting and learning information about changing of the temperature or adjusting of the spray force by the user after the automatic control.

Further, the present disclosure may increase the ease of use and efficiency by automatically controlling the dish washer in the home using the user context analysis.

The effects achievable in the present disclosure are not limited to those mentioned above. Other effects not mentioned will be clearly understood by those skilled in the art from the description below.

### BRIEF DESCRIPTION OF THE DRAWINGS

The accompanying drawings, which are included to provide a further understanding of the disclosure, illustrate embodiments of the disclosure and together with the description serve to explain the principle of the disclosure.

FIG. 1 is a conceptual diagram showing one embodiment of an AI device.

FIG. 2 illustrates a block diagram of a wireless communication system to which the methods proposed in the present disclosure may be applied.

FIG. 3 shows an example of a signal transmission/reception method in a wireless communication system.

FIG. 4 shows an example of a basic operation of a user terminal and 5G network in the 5G communication system.

FIG. 5 is a diagram illustrating an intelligent dish washer according to one embodiment of the present disclosure.

FIG. 6 illustrates a block diagram of an intelligent dish washer according to one embodiment of the present disclosure.

FIG. 7 is a block diagram of an AI device according to one embodiment of the present disclosure.

FIG. 8 is a diagram for explaining a system in which an intelligent device is connected to an AI device according to an embodiment of the present disclosure.

FIG. 9 illustrates the control method of an intelligent dish washer according to one embodiment of the present disclosure.

FIG. 10 is a view for explaining an example of determining the washing state of the dish according to one embodiment of the present disclosure.

FIG. 11 illustrates another example of determining the washing state of a dish according to one embodiment of the present disclosure.

FIG. 12 is a flow chart illustrating an example of a control method of an intelligent dish washer that sets a washing mode according to one embodiment of the present disclosure.

FIG. 13 is a flowchart illustrating another example of a control method of an intelligent dish washer that sets a washing mode according to one embodiment of the present disclosure.

FIG. 14 is a flow chart illustrating another example of a control method of an intelligent dish washer that sets a washing mode according to one embodiment of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus may be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

[5G Scenario]

The three main requirement areas in the 5G system are (1) enhanced Mobile Broadband (eMBB) area, (2) massive Machine Type Communication (mMTC) area, and (3) Ultra-Reliable and Low Latency Communication (URLLC) area.

Some use case may require a plurality of areas for optimization, but other use case may focus only one Key Performance Indicator (KPI). The 5G system supports various use cases in a flexible and reliable manner.

eMBB far surpasses the basic mobile Internet access, supports various interactive works, and covers media and entertainment applications in the cloud computing or augmented reality environment. Data is one of core driving elements of the 5G system, which is so abundant that for the first time, the voice-only service may be disappeared. In the 5G, voice is expected to be handled simply by an application program using a data connection provided by the communication system. Primary causes of increased volume of traffic are increase of content size and increase of the number of applications requiring a high data transfer rate. Streaming service (audio and video), interactive video, and mobile Internet connection will be more heavily used as more and more devices are connected to the Internet. These application programs require always-on connectivity to push real-time information and notifications to the user. Cloud-based storage and applications are growing rapidly in the mobile communication platforms, which may be applied to both of business and entertainment uses. And the cloud-based storage is a special use case that drives growth of uplink data transfer rate. The 5G is also used for cloud-based remote works and requires a much shorter end-to-end latency to ensure excellent user experience when a tactile interface is used. Entertainment, for example, cloud-based game and video streaming, is another core element that strengthens the requirement for mobile broadband capability. Entertainment is essential for smartphones and tablets in any place including a high mobility environment such as a train, car, and plane. Another use case is augmented reality for entertainment and information search. Here, augmented reality requires very low latency and instantaneous data transfer.

Also, one of highly expected 5G use cases is the function that connects embedded sensors seamlessly in every possible area, namely the use case based on mMTC. Up to 2020, the number of potential IoT devices is expected to reach 20.4 billion. Industrial IoT is one of key areas where the 5G performs a primary role to maintain infrastructure for smart city, asset tracking, smart utility, agriculture and security.

URLLC includes new services which may transform industry through ultra-reliable/ultra-low latency links, such as remote control of major infrastructure and self-driving cars. The level of reliability and latency are essential for smart grid control, industry automation, robotics, and drone control and coordination.

Next, a plurality of use cases will be described in more detail.

The 5G may complement Fiber-To-The-Home (FTTH) and cable-based broadband (or DOCSIS) as a means to provide a stream estimated to occupy hundreds of megabits per second up to gigabits per second. This fast speed is required not only for virtual reality and augmented reality but also for transferring video with a resolution more than 4K (6K, 8K or more). VR and AR applications almost always include immersive sports games. Specific application programs may require a special network configuration. For example, in the case of VR game, to minimize latency, game service providers may have to integrate a core server with the edge network service of the network operator.

Automobiles are expected to be a new important driving force for the 5G system together with various use cases of mobile communication for vehicles. For example, entertainment for passengers requires high capacity and high mobile broadband at the same time. This is so because users continue to expect a high-quality connection irrespective of their location and moving speed. Another use case in the automotive field is an augmented reality dashboard. The augmented reality dashboard overlays information, which is a perception result of an object in the dark and contains distance to the object and object motion, on what is seen through the front window. In a future, a wireless module enables communication among vehicles, information exchange between a vehicle and supporting infrastructure, and information exchange among a vehicle and other connected devices (for example, devices carried by a pedestrian). A safety system guides alternative courses of driving so that a driver may drive his or her vehicle more safely and to reduce the risk of accident. The next step will be a remotely driven or self-driven vehicle. This step requires highly reliable and highly fast communication between different self-driving vehicles and between a self-driving vehicle and infrastructure. In the future, it is expected that a self-driving vehicle takes care of all of the driving activities while a human driver focuses on dealing with an abnormal driving situation that the self-driving vehicle is unable to recognize. Technical requirements of a self-driving vehicle demand ultra-low latency and ultra-fast reliability up to the level that traffic safety may not be reached by human drivers.

The smart city and smart home, which are regarded as essential to realize a smart society, will be embedded into a high-density wireless sensor network. Distributed networks comprising intelligent sensors may identify conditions for cost-efficient and energy-efficient conditions for maintaining cities and homes. A similar configuration may be applied for each home. Temperature sensors, window and heating controllers, anti-theft alarm devices, and home appliances will be all connected wirelessly. Many of these sensors typified with a low data transfer rate, low power, and low cost. However, for example, real-time HD video may require specific types of devices for the purpose of surveillance.

As consumption and distribution of energy including heat or gas is being highly distributed, automated control of a distributed sensor network is required. A smart grid collects information and interconnect sensors by using digital information and communication technologies so that the distributed sensor network operates according to the collected information. Since the information may include behaviors of energy suppliers and consumers, the smart grid may help improving distribution of fuels such as electricity in terms of efficiency, reliability, economics, production sustainability, and automation. The smart grid may be regarded as a different type of sensor network with a low latency.

The health-care sector has many application programs that may benefit from mobile communication. A communication system may support telemedicine providing a clinical care from a distance. Telemedicine may help reduce barriers to distance and improve access to medical services that are not readily available in remote rural areas. It may also be used to save lives in critical medical and emergency situations. A wireless sensor network based on mobile communication may provide remote monitoring and sensors for parameters such as the heart rate and blood pressure.

Wireless and mobile communication are becoming increasingly important for industrial applications. Cable wiring requires high installation and maintenance costs. Therefore, replacement of cables with reconfigurable wireless links is an attractive opportunity for many industrial applications. However, to exploit the opportunity, the wireless connection is required to function with a latency similar to that in the cable connection, to be reliable and of large capacity, and to be managed in a simple manner Low latency and very low error probability are new requirements that lead to the introduction of the 5G system.

Logistics and freight tracking are important use cases of mobile communication, which require tracking of an inventory and packages from any place by using location-based information system. The use of logistics and freight tracking typically requires a low data rate but requires large-scale and reliable location information.

The present disclosure to be described below may be implemented by combining or modifying the respective embodiments to satisfy the aforementioned requirements of the 5G system.

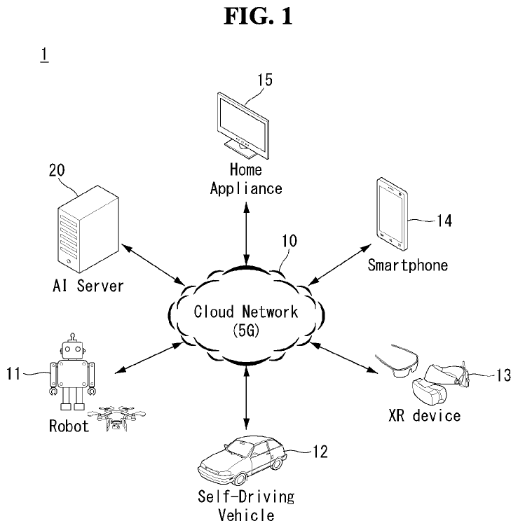

FIG. 1 illustrates one embodiment of an AI device.

Referring to FIG. 1, in the AI system, at least one or more of an AI server 16, robot 11, self-driving vehicle 12, XR device 13, smartphone 14, or home appliance 15 are connected to a cloud network 10. Here, the robot 11, self-driving vehicle 12, XR device 13, smartphone 14, or home appliance 15 to which the AI technology has been applied may be referred to as an AI device (11 to 15).

The cloud network 10 may comprise part of the cloud computing infrastructure or refer to a network existing in the cloud computing infrastructure. Here, the cloud network 10 may be constructed by using the 3G network, 4G or Long Term Evolution (LTE) network, or 5G network.

In other words, individual devices (11 to 16) constituting the AI system may be connected to each other through the cloud network 10. In particular, each individual device (11 to 16) may communicate with each other through the eNB but may communicate directly to each other without relying on the eNB.

The AI server 16 may include a server performing AI processing and a server performing computations on big data.

The AI server 16 may be connected to at least one or more of the robot 11, self-driving vehicle 12, XR device 13, smartphone 14, or home appliance 15, which are AI devices constituting the AI system, through the cloud network 10 and may help at least part of AI processing conducted in the connected AI devices (11 to 15).

At this time, the AI server 16 may teach the artificial neural network according to a machine learning algorithm on behalf of the AI device (11 to 15), directly store the learning model, or transmit the learning model to the AI device (11 to 15).

At this time, the AI server 16 may receive input data from the AI device (11 to 15), infer a result value from the received input data by using the learning model, generate a response or control command based on the inferred result value, and transmit the generated response or control command to the AI device (11 to 15).

Similarly, the AI device (11 to 15) may infer a result value from the input data by employing the learning model directly and generate a response or control command based on the inferred result value.

<AI+Robot>

By employing the AI technology, the robot 11 may be implemented as a guide robot, transport robot, cleaning robot, wearable robot, entertainment robot, pet robot, or unmanned flying robot.

The robot 11 may include a robot control module for controlling its motion, where the robot control module may correspond to a software module or a chip which implements the software module in the form of a hardware device.

The robot 11 may obtain status information of the robot 11, detect (recognize) the surroundings and objects, generate map data, determine a travel path and navigation plan, determine a response to user interaction, or determine motion by using sensor information obtained from various types of sensors.

Here, the robot 11 may use sensor information obtained from at least one or more sensors among lidar, radar, and camera to determine a travel path and navigation plan.

The robot 11 may perform the operations above by using a learning model built on at least one or more artificial neural networks. For example, the robot 11 may recognize the surroundings and objects by using the learning model and determine its motion by using the recognized surroundings or object information. Here, the learning model may be the one trained by the robot 11 itself or trained by an external device such as the AI server 16.

At this time, the robot 11 may perform the operation by generating a result by employing the learning model directly but also perform the operation by transmitting sensor information to an external device such as the AI server 16 and receiving a result generated accordingly.

The robot 11 may determine a travel path and navigation plan by using at least one or more of object information detected from the map data and sensor information or object information obtained from an external device and navigate according to the determined travel path and navigation plan by controlling its locomotion platform.

Map data may include object identification information about various objects disposed in the space in which the robot 11 navigates. For example, the map data may include object identification information about static objects such as wall and doors and movable objects such as a flowerpot and a desk. And the object identification information may include the name, type, distance, location, and so on.

Also, the robot 11 may perform the operation or navigate the space by controlling its locomotion platform based on the control/interaction of the user. At this time, the robot 11 may obtain intention information of the interaction due to the user's motion or voice command and perform an operation by determining a response based on the obtained intention information.

<AI+Autonomous Navigation>

By employing the AI technology, the self-driving vehicle 12 may be implemented as a mobile robot, unmanned ground vehicle, or unmanned aerial vehicle.

The self-driving vehicle 12 may include an autonomous navigation module for controlling its autonomous navigation function, where the autonomous navigation control module may correspond to a software module or a chip which implements the software module in the form of a hardware device. The autonomous navigation control module may be installed inside the self-driving vehicle 12 as a constituting element thereof or may be installed outside the self-driving vehicle 12 as a separate hardware component.

The self-driving vehicle 12 may obtain status information of the self-driving vehicle 12, detect (recognize) the surroundings and objects, generate map data, determine a travel path and navigation plan, or determine motion by using sensor information obtained from various types of sensors.

Like the robot 11, the self-driving vehicle 12 may use sensor information obtained from at least one or more sensors among lidar, radar, and camera to determine a travel path and navigation plan.

In particular, the self-driving vehicle 12 may recognize an occluded area or an area extending over a predetermined distance or objects located across the area by collecting sensor information from external devices or receive recognized information directly from the external devices.

The self-driving vehicle 12 may perform the operations above by using a learning model built on at least one or more artificial neural networks. For example, the self-driving vehicle 12 may recognize the surroundings and objects by using the learning model and determine its navigation route by using the recognized surroundings or object information. Here, the learning model may be the one trained by the self-driving vehicle 12 itself or trained by an external device such as the AI server 16.

At this time, the self-driving vehicle 12 may perform the operation by generating a result by employing the learning model directly but also perform the operation by transmitting sensor information to an external device such as the AI server 16 and receiving a result generated accordingly.

The self-driving vehicle 12 may determine a travel path and navigation plan by using at least one or more of object information detected from the map data and sensor information or object information obtained from an external device and navigate according to the determined travel path and navigation plan by controlling its driving platform.

Map data may include object identification information about various objects disposed in the space (for example, road) in which the self-driving vehicle 12 navigates. For example, the map data may include object identification information about static objects such as streetlights, rocks and buildings and movable objects such as vehicles and pedestrians. And the object identification information may include the name, type, distance, location, and so on.

Also, the self-driving vehicle 12 may perform the operation or navigate the space by controlling its driving platform based on the control/interaction of the user. At this time, the self-driving vehicle 12 may obtain intention information of the interaction due to the user's motion or voice command and perform an operation by determining a response based on the obtained intention information.

<AI+XR>

By employing the AI technology, the XR device 13 may be implemented as a Head-Mounted Display (HMD), Head-Up Display (HUD) installed at the vehicle, TV, mobile phone, smartphone, computer, wearable device, home appliance, digital signage, vehicle, robot with a fixed platform, or mobile robot.

The XR device 13 may obtain information about the surroundings or physical objects by generating position and attribute data about 3D points by analyzing 3D point cloud or image data acquired from various sensors or external devices and output objects in the form of XR objects by rendering the objects for display.

The XR device 13 may perform the operations above by using a learning model built on at least one or more artificial neural networks. For example, the XR device 13 may recognize physical objects from 3D point cloud or image data by using the learning model and provide information corresponding to the recognized physical objects. Here, the learning model may be the one trained by the XR device 13 itself or trained by an external device such as the AI server 16.

At this time, the XR device 13 may perform the operation by generating a result by employing the learning model directly but also perform the operation by transmitting sensor information to an external device such as the AI server 16 and receiving a result generated accordingly.

<AI+Robot+Autonomous Navigation>

By employing the AI and autonomous navigation technologies, the robot 11 may be implemented as a guide robot, transport robot, cleaning robot, wearable robot, entertainment robot, pet robot, or unmanned flying robot.

The robot 11 employing the AI and autonomous navigation technologies may correspond to a robot itself having an autonomous navigation function or a robot 11 interacting with the self-driving vehicle 12.

The robot 11 having the autonomous navigation function may correspond collectively to the devices which may move autonomously along a given path without control of the user or which may move by determining its path autonomously.

The robot 11 and the self-driving vehicle 12 having the autonomous navigation function may use a common sensing method to determine one or more of the travel path or navigation plan. For example, the robot 11 and the self-driving vehicle 12 having the autonomous navigation function may determine one or more of the travel path or navigation plan by using the information sensed through lidar, radar, and camera.

The robot 11 interacting with the self-driving vehicle 12, which exists separately from the self-driving vehicle 12, may be associated with the autonomous navigation function inside or outside the self-driving vehicle 12 or perform an operation associated with the user riding the self-driving vehicle 12.

At this time, the robot 11 interacting with the self-driving vehicle 12 may obtain sensor information in place of the self-driving vehicle 12 and provide the sensed information to the self-driving vehicle 12; or may control or assist the autonomous navigation function of the self-driving vehicle 12 by obtaining sensor information, generating information of the surroundings or object information, and providing the generated information to the self-driving vehicle 12.

Also, the robot 11 interacting with the self-driving vehicle 12 may control the function of the self-driving vehicle 12 by monitoring the user riding the self-driving vehicle 12 or through interaction with the user. For example, if it is determined that the driver is drowsy, the robot 11 may activate the autonomous navigation function of the self-driving vehicle 12 or assist the control of the driving platform of the self-driving vehicle 12. Here, the function of the self-driving vehicle 12 controlled by the robot 12 may include not only the autonomous navigation function but also the navigation system installed inside the self-driving vehicle 12 or the function provided by the audio system of the self-driving vehicle 12.

Also, the robot 11 interacting with the self-driving vehicle 12 may provide information to the self-driving vehicle 12 or assist functions of the self-driving vehicle 12 from the outside of the self-driving vehicle 12. For example, the robot 11 may provide traffic information including traffic sign information to the self-driving vehicle 12 like a smart traffic light or may automatically connect an electric charger to the charging port by interacting with the self-driving vehicle 12 like an automatic electric charger of the electric vehicle.

<AI+Robot+Xr>

By employing the AI technology, the robot 11 may be implemented as a guide robot, transport robot, cleaning robot, wearable robot, entertainment robot, pet robot, or unmanned flying robot.

The robot 11 employing the XR technology may correspond to a robot which acts as a control/interaction target in the XR image. In this case, the robot 11 may be distinguished from the XR device 13, both of which may operate in conjunction with each other.

If the robot 11, which acts as a control/interaction target in the XR image, obtains sensor information from the sensors including a camera, the robot 11 or XR device 13 may generate an XR image based on the sensor information, and the XR device 13 may output the generated XR image. And the robot 11 may operate based on the control signal received through the XR device 13 or based on the interaction with the user.

For example, the user may check the XR image corresponding to the viewpoint of the robot 11 associated remotely through an external device such as the XR device 13, modify the navigation path of the robot 11 through interaction, control the operation or navigation of the robot 11, or check the information of nearby objects.

<AI+Autonomous Navigation+XR>

By employing the AI and XR technologies, the self-driving vehicle 12 may be implemented as a mobile robot, unmanned ground vehicle, or unmanned aerial vehicle.

The self-driving vehicle 12 employing the XR technology may correspond to a self-driving vehicle having a means for providing XR images or a self-driving vehicle which acts as a control/interaction target in the XR image. In particular, the self-driving vehicle 12 which acts as a control/interaction target in the XR image may be distinguished from the XR device 13, both of which may operate in conjunction with each other.

The self-driving vehicle 12 having a means for providing XR images may obtain sensor information from sensors including a camera and output XR images generated based on the sensor information obtained. For example, by displaying an XR image through HUD, the self-driving vehicle 12 may provide XR images corresponding to physical objects or image objects to the passenger.

At this time, if an XR object is output on the HUD, at least part of the XR object may be output so as to be overlapped with the physical object at which the passenger gazes. On the other hand, if an XR object is output on a display installed inside the self-driving vehicle 12, at least part of the XR object may be output so as to be overlapped with an image object. For example, the self-driving vehicle 12 may output XR objects corresponding to the objects such as roads, other vehicles, traffic lights, traffic signs, bicycles, pedestrians, and buildings.

If the self-driving vehicle 12, which acts as a control/interaction target in the XR image, obtains sensor information from the sensors including a camera, the self-driving vehicle 12 or XR device 13 may generate an XR image based on the sensor information, and the XR device 13 may output the generated XR image. And the self-driving vehicle 12 may operate based on the control signal received through an external device such as the XR device 13 or based on the interaction with the user.

[Extended Reality Technology]

eXtended Reality (XR) refers to all of Virtual Reality (VR), Augmented Reality (AR), and Mixed Reality (MR). The VR technology provides objects or backgrounds of the real world only in the form of CG images, AR technology provides virtual CG images overlaid on the physical object images, and MR technology employs computer graphics technology to mix and merge virtual objects with the real world.

MR technology is similar to AR technology in a sense that physical objects are displayed together with virtual objects. However, while virtual objects supplement physical objects in the AR, virtual and physical objects co-exist as equivalents in the MR.

The XR technology may be applied to Head-Mounted Display (HMD), Head-Up Display (HUD), mobile phone, tablet PC, laptop computer, desktop computer, TV, digital signage, and so on, where a device employing the XR technology may be called an XR device.

Hereinafter, 5G communication (5th generation mobile communication) required by an apparatus requiring AI processed information and/or an AI processor will be described through paragraphs A through G.

A. Example of Block Diagram of UE and 5G Network

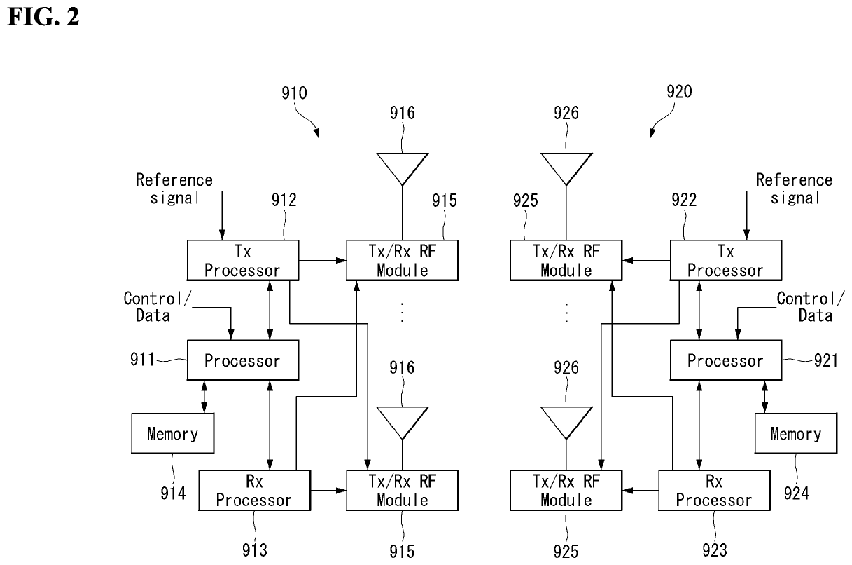

FIG. 2 is a block diagram of a wireless communication system to which methods proposed in the disclosure are applicable.

Referring to FIG. 2, a device (autonomous device) including an autonomous module is defined as a first communication device (910 of FIG. 2), and a processor 911 can perform detailed autonomous operations.

A 5G network including another vehicle communicating with the autonomous device is defined as a second communication device (920 of FIG. 2), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 2, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

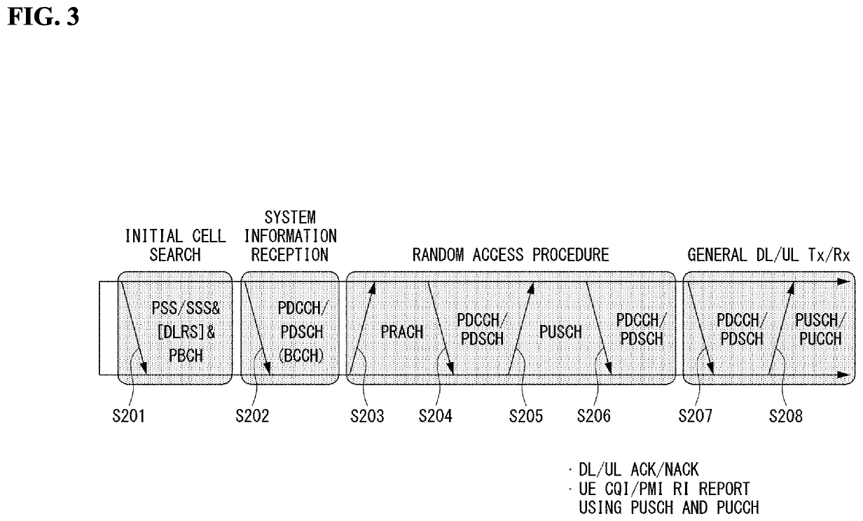

FIG. 3 is a diagram showing an example of a signal transmission/reception method in a wireless communication system.

Referring to FIG. 3, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 3.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 3.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

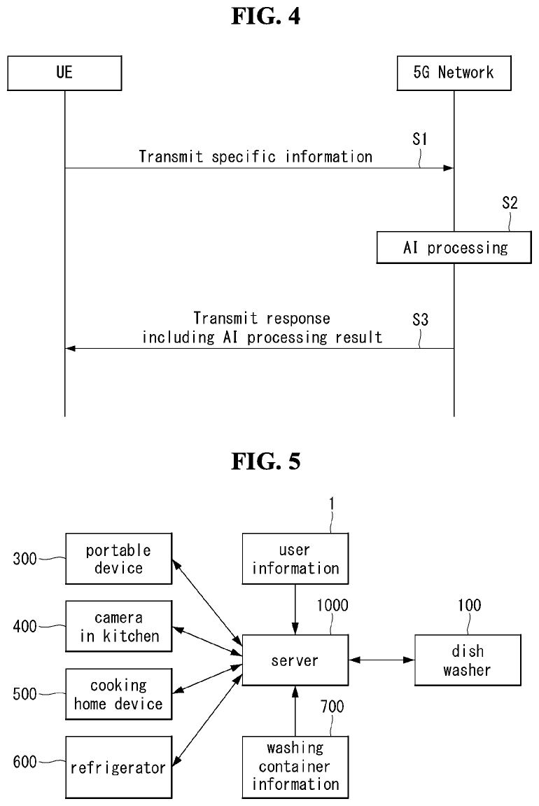

FIG. 4 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 2 and 3.

First, a basic procedure of an applied operation to which a method proposed by the present disclosure which will be described later and eMBB of 5G communication are applied will be described.

As in steps S1 and S3 of FIG. 4, the autonomous vehicle performs an initial access procedure and a random access procedure with the 5G network prior to step S1 of FIG. 4 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 4 which are changed according to application of mMTC.

In step S1 of FIG. 4, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

FIG. 5 is a diagram illustrating an intelligent dish washer according to one embodiment of the present disclosure.

Referring to FIG. 5, an intelligent dish washer 100 may interact with server 1000. The interaction may refer to the exchange of necessary information between the server 1000 and components of the intelligent dish washer 100.

The intelligent dish washer 100 may obtain cooking information from external devices 300, 400, 500, and 600 via the server 1000. The external devices 300, 400, 500, and 600 may be referred to as external devices. The external devices 300, 400, 500, and 600 may include a cooking home device 500, portable device 300, camera 400 installed in kitchen, refrigerator 600, etc. For example, the cooking home device 500 may be an electric oven or a microwave oven. The server 1000 may transmit the optimal washing mode to the intelligent dish washer 100 based on the analysis of the server 1000.

The cooking information includes first food information about foods being cooked from the cooking home device 500, recipe information collected based on a recipe retrieved from the portable device 300, second food information about foods being cooked in the gas range or the cooktop as collected from the camera 400 installed in the kitchen or the fan, cooking material information about cooking materials used from the cooking among cooking materials stored in the refrigerator 600, the user information, dish shape information, and the like.

The server 1000 may receive and store the user information 1 or washing dish information 700.

The user information 1 may include information such as the user's gender, family size, and a baby presence or absence. The washing dish information 700 may include dish shape information. The server may identify the dish shape information to determine whether a dish is a baby dish or a container used for specific cooking.

In accordance with the present disclosure, an intelligent dish washer itself, or a server or 5G network may use the cooking information to determine the washing state of the dish.

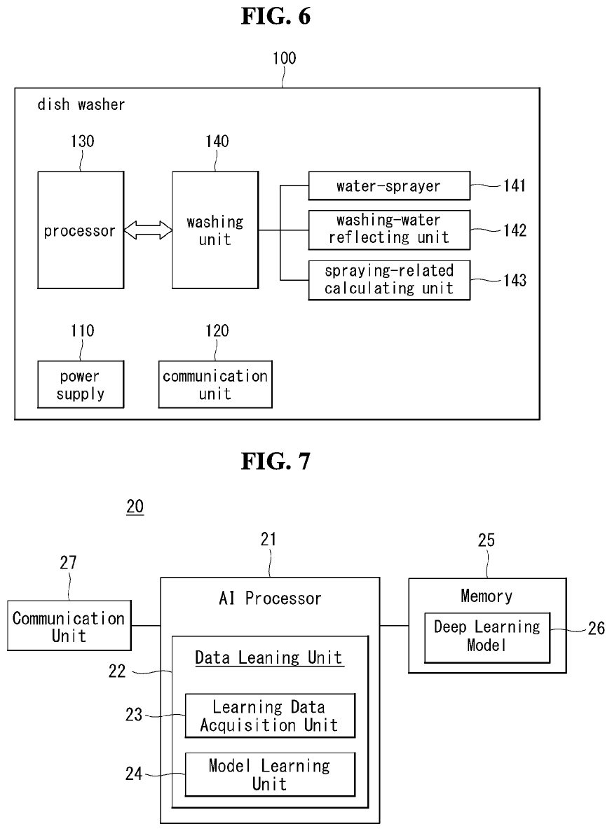

FIG. 6 illustrates a block diagram of an intelligent dish washer according to one embodiment of the present disclosure.

Referring to FIG. 6, an intelligent dish washer 100 according to one embodiment of the present disclosure may include a processor 130, a power supply 110, a washing unit 140, and a communication unit 120.

The processor 130 may control or interact with the washing unit 140. The interaction may refer to the exchange of necessary information between components of an intelligent dish washer 100.

The processor 130 receives the cooking information from the communication unit 120 and learns dish washing information to wash dishes used for cooking based on the cooking information as provided. Based on the result of the learned dish washing information, the processor may determine the washing mode for washing the dish.

The power supply 110 may supply power to the dish washer 100.

The washing unit 140 may wash dishes or objects using various washing modes under the control of the processor 130. The washing unit 140 may include a water-sprayer 141, a washing-water reflecting unit 142, and a spraying-related calculating unit 143.

The spraying-related calculating unit 143 may calculate a route for spray the washing-water to an object. The spraying-related calculating unit 143 may determine the positions of the water-sprayer 141 and the washing-water reflecting unit 142 such that the washing-water reaches the calculated route.

The washing unit 140 may wash the object based on the calculated path and positions using the water-sprayer 141 and the washing-water reflecting unit 142.

The water-sprayer 141 may spray washing-water along the calculated route.

The washing-water reflecting unit 142 may wash the object by reflecting the washing-water sprayed by the water-sprayer 141. The washing-water reflecting unit 142 may operate in an interconnected manner with the water-sprayer 141.

The communication unit 120 may communicate with an external device. The communication unit 120 is provided in the body of the intelligent dish washer, and may receive the cooking information about cooking provided from at least one or more of the plurality of external devices.

FIG. 7 is a block diagram of an AI device in accordance with the embodiment of the present disclosure.

The AI device 20 may include electronic equipment that includes an AI module to perform AI processing or a server that includes the AI module. Furthermore, the AI device 20 may be included in at least a portion of the intelligent dish washer 100 illustrated in FIG. 7, and may be provided to perform at least some of the AI processing.

The AI processing may include all operations related to the function of the intelligent dish washer 100 illustrated in FIG. 6. For example, the intelligent robot cleaner may AI-process sensing data or travel data to perform processing/determining and a control-signal generating operation. Furthermore, for example, the intelligent robot cleaner may AI-process data acquired through interaction with other electronic equipment provided in the intelligent robot cleaner to control sensing.

The AI device 20 may include an AI processor 21, a memory 25 and/or a communication unit 27.

The AI device 20 may be a computing device capable of learning a neural network, and may be implemented as various electronic devices such as a server, a desktop PC, a laptop PC or a tablet PC.

The AI processor 21 may learn the neural network using a program stored in the memory 25. Particularly, the AI processor 21 may learn the neural network for recognizing data related to the intelligent dish washer 100. Here, the neural network for recognizing data related to the intelligent dish washer 100 may be designed to simulate a human brain structure on the computer, and may include a plurality of network nodes having weights that simulate the neurons of the human neural network. The plurality of network nodes may exchange data according to the connecting relationship to simulate the synaptic action of neurons in which the neurons exchange signals through synapses. Here, the neural network may include the deep learning model developed from the neural network model. While the plurality of network nodes is located at different layers in the deep learning model, the nodes may exchange data according to the convolution connecting relationship. Examples of the neural network model include various deep learning techniques, such as a deep neural network (DNN), a convolution neural network (CNN), a recurrent neural network (RNN, Recurrent Boltzmann Machine), a restricted Boltzmann machine (RBM), a deep belief network (DBN) or a deep Q-Network, and may be applied to fields such as computer vision, voice recognition, natural language processing, voice/signal processing or the like.

Meanwhile, the processor performing the above-described function may be a general-purpose processor (e.g. CPU), but may be an AI dedicated processor (e.g. GPU) for artificial intelligence learning.

The memory 25 may store various programs and data required to operate the AI device 20. The memory 25 may be implemented as a non-volatile memory, a volatile memory, a flash memory), a hard disk drive (HDD) or a solid state drive (SDD). The memory 25 may be accessed by the AI processor 21, and reading/writing/correcting/deleting/update of data by the AI processor 21 may be performed.

Furthermore, the memory 25 may store the neural network model (e.g. the deep learning model 26) generated through a learning algorithm for classifying/recognizing data in accordance with the embodiment of the present disclosure.

The AI processor 21 may include a data learning unit 22 which learns the neural network for data classification/recognition. The data learning unit 22 may learn a criterion about what learning data is used to determine the data classification/recognition and about how to classify and recognize data using the learning data. The data learning unit 22 may learn the deep learning model by acquiring the learning data that is used for learning and applying the acquired learning data to the deep learning model.

The data learning unit 22 may be made in the form of at least one hardware chip and may be mounted on the AI device 20. For example, the data learning unit 22 may be made in the form of a dedicated hardware chip for the artificial intelligence AI, and may be made as a portion of the general-purpose processor (CPU) or the graphic dedicated processor (GPU) to be mounted on the AI device 20. Furthermore, the data learning unit 22 may be implemented as a software module. When the data learning unit is implemented as the software module (or a program module including instructions), the software module may be stored in a non-transitory computer readable medium. In this case, at least one software module may be provided by an operating system (OS) or an application.

The data learning unit 22 may include the learning-data acquisition unit 23 and the model learning unit 24.

The learning-data acquisition unit 23 may acquire the learning data needed for the neural network model for classifying and recognizing the data. For example, the learning-data acquisition unit 23 may acquire vehicle data and/or sample data which are to be inputted into the neural network model, as the learning data.

The model learning unit 24 may learn to have a determination criterion about how the neural network model classifies predetermined data, using the acquired learning data. The model learning unit 24 may learn the neural network model, through supervised learning using at least some of the learning data as the determination criterion. Alternatively, the model learning unit 24 may learn the neural network model through unsupervised learning that finds the determination criterion, by learning by itself using the learning data without supervision. Furthermore, the model learning unit 24 may learn the neural network model through reinforcement learning using feedback on whether the result of situation determination according to the learning is correct. Furthermore, the model learning unit 24 may learn the neural network model using the learning algorithm including error back-propagation or gradient descent.

If the neural network model is learned, the model learning unit 24 may store the learned neural network model in the memory. The model learning unit 24 may store the learned neural network model in the memory of the server connected to the AI device 20 with a wire or wireless network.

The data learning unit 22 may further include a learning-data preprocessing unit (not shown) and a learning-data selection unit (not shown) to improve the analysis result of the recognition model or to save resources or time required for generating the recognition model.

The learning-data preprocessing unit may preprocess the acquired data so that the acquired data may be used for learning for situation determination. For example, the learning-data preprocessing unit may process the acquired data in a preset format so that the model learning unit 24 may use the acquired learning data for learning for image recognition.

Furthermore, the learning-data selection unit may select the data required for learning among the learning data acquired by the learning-data acquisition unit 23 or the learning data preprocessed in the preprocessing unit. The selected learning data may be provided to the model learning unit 24. For example, the learning-data selection unit may select only data on the object included in a specific region as the learning data, by detecting the specific region in the image acquired by the camera of the intelligent dish washer 100.

Furthermore, the data learning unit 22 may further include a model evaluation unit (not shown) to improve the analysis result of the neural network model.

When the model evaluation unit inputs evaluated data into the neural network model and the analysis result outputted from the evaluated data does not satisfy a predetermined criterion, the model learning unit 22 may learn again. In this case, the evaluated data may be predefined data for evaluating the recognition model. By way of example, the model evaluation unit may evaluate that the predetermined criterion is not satisfied when the number or ratio of the evaluated data in which the analysis result is inaccurate among the analysis result of the learned recognition model for the evaluated data exceeds a preset threshold.

The communication unit 27 may transmit the AI processing result by the AI processor 21 to the external electronic equipment.

Here, the external electronic equipment may be defined as the intelligent dish washer 100. Furthermore, the AI device 20 may be defined as another intelligent dish washer 100 or a 5G network that communicates with the intelligent dish washer 100. Meanwhile, the AI device 20 may be implemented by being functionally embedded in an autonomous driving module provided in the intelligent dish washer 100. Furthermore, the 5G network may include a server or a module that performs related control of the intelligent dish washer 100.

Although the AI device 20 illustrated in FIG. 7 is functionally divided into the AI processor 21, the memory 25, the communication unit 27 and the like, it is to be noted that the above-described components are integrated into one module, which is referred to as an AI module.

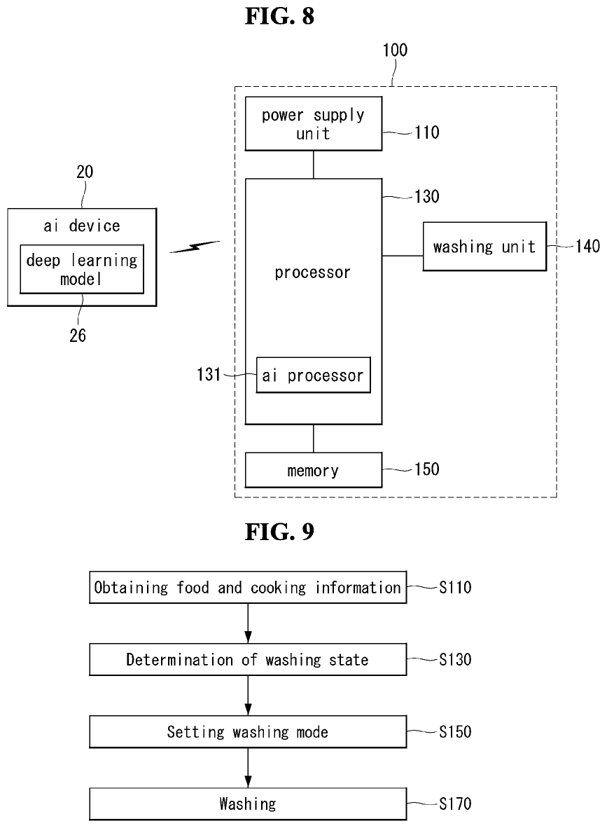

FIG. 8 is a diagram for explaining a system in which an intelligent device is connected to an AI device according to an embodiment of the present disclosure.

Referring to FIG. 8, the intelligent dish washer 100 may send data that is subjected to AI processing to the AI device 20 using a communication unit. The AI device 20 including the deep-learning model 26 may transmit the AI processing result using the deep-learning model 26 to the intelligent dish washer 100. The AI device 20 is as described with reference to FIG. 7.

The intelligent dish washer 100 may include a memory 150, a processor 130, a power supply 110, a washing unit 140 and a communication unit 120. In FIG. 8, the memory 150, the processor 130, the power supply 110, the washing unit 140, and the communication unit 120 have substantially the same components, effects, and functions as described in FIG. 6, a description thereof will be omitted.

The intelligent dish washer 100 transmits the data obtained using at least one sensor to AI device 20 using the communication unit 120. The AI device 20 may apply the neural network model 26 to the transmitted data and then transmit the generated AI processing data to the intelligent dish washer 100. The intelligent dish washer 100 recognizes the detected or sensed information based on the received AI processing data. Then, the intelligent dish washer 100 may use the recognized information to perform the overall control operation for the intelligent dish washer 100, for example, to control the washing state of the intelligent dish washer 100 and the door state of the intelligent dish washer 100.

The washing unit 140 may use a washing control signal generated by the AI processor 171 applying a neural network model to data related to the intelligent dish washer 100. The washing control signal may be a signal received from an external AI device 20 using the communication unit 120.

The AI processor 171 may generate washing state data of an intelligent dish washer 100 by applying a neural network model to sensing data generated by at least one sensor. AI processing data generated by applying the neural network model may include washing data related to washing of the dish washer 100 and dish data related to the dish of the dish washer 100.

The intelligent dish washer 100 transmits the sensing data acquired using at least one sensor to the AI device 20 using the communication unit 120. The AI device 20 may apply the neural network model 26 to the sensing data as transmitted to generate the AI processing data which in turn may be transmitted to the intelligent dish washer 100.

According to one embodiment, the AI processor 171 performs a deep-learning computing based on the plurality of data sensed by the sensing unit 240 to generate the AI processing data. The dish washing data of the intelligent dish washer 100 may be corrected based on the generated AI processing data.

The intelligent dish washer 100 may include an internal communication system (not shown). A plurality of electronic devices or electronic devices included in the intelligent dish washer 100 may exchange signals via the internal communication system (not shown). The signal may include data. The internal communication systems (not shown) may use at least one communication protocols such as CAN, LIN, FlexRay, MOST, and Ethernet.

The AI processor 171 may apply washing related information received from at least one sensor provided in the intelligent dish washer 100 and an external device to the neural network model.

In the above descriptions, the 5G communication necessary to implement the method for controlling the intelligent dish washer 100 according to one embodiment of the present disclosure, the AI processing as performed by applying the 5G communication, and the sending and receiving of the AI processing results have been described.

Hereinafter, specific methods for determining the dish washing state of the dish washer 100 based on various cooking information obtained by the intelligent dish washer 100 according to one embodiment of the present disclosure, and actively controlling the determined result will be described with reference to the accompanying drawings.

FIG. 9 illustrates the control method of the intelligent dish washer according to one embodiment of the present disclosure.

The control method of the intelligent dish washer according to one embodiment of the present disclosure may be implemented by the intelligent dish washer including the functions described with reference to FIGS. 5 to 8. More specifically, the control method of the intelligent dish washer according to the one embodiment of the present disclosure may be implemented by the intelligent dish washer 100 as described in FIG. 5 to FIG. 8.

The processor 130 may obtain cooking information from an external device. The external device may include a cooking home device, a portable device, a camera installed in a kitchen, a refrigerator, and the like. The cooking information includes first food information about the food being cooked from a cooking home device (e.g., an electric oven, microwave oven, etc.), recipe information collected based on recipes retrieved from a portable device, second food information about foods being cooked in the gas range or cooktop as collected from the camera installed in the kitchen or ventilator, cooking material information about cooking materials used for cooking among the food ingredients stored in the refrigerator, the user information, dish shape information and the like.

For example, the intelligent dish washer may use the user information to control a sterilization degree. The user information may include information such as the user's gender, family size, and the presence or absence of a baby. The intelligent dish washer may adjust the diet or the sterilization rate based on the user's information. The intelligent dish washer may use the dish shape information to select the spray force required for washing. The intelligent dish washer may enhance the washing force and sterilization degree when the baby items are included in the dish shape information.

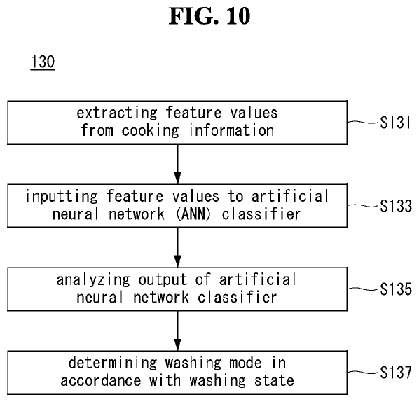

The processor 130 may determine or predict the washing state of the dish based on the acquired cooking information. A detailed process of determining the washing state of the dish will be described later in FIG. 10. As described above, the washing state determination for the dish based on the cooking information may be made by the intelligent dish washer itself or by a 5G network.

The processor 130 may set the washing mode according to the determined washing state for the dish S150. The processor 130 may set washing modes varying according to the determined washing state for the dish. For example, the washing mode may include a standard washing mode, a strong washing mode, a simple washing mode, a sterilizing washing mode, and the like. The standard washing mode may be a mode in which general washing is possible when information on the oily food in the cooking information is less than or equal to a predetermined threshold value. The strong washing mode may be a mode in which strong washing is possible when the information on the oily food in the cooking information is greater than or equal to a predetermined threshold value. The simple washing mode may be a mode in which relatively simple washing is possible and information about oily food is absent in the cooking information. The sterilization washing mode may be a mode in which washing and sterilization are possible at the same time when a dish is related to a baby or an infant. That is, the processor 130 may set one of the standard washing mode, the strong washing mode, the simple washing mode, and the sterilizing washing mode according to the determined washing state of the dish.

The processor 130 may wash the dish according to the set washing mode.

As described above, the intelligent dish washer according to one embodiment of the present disclosure may determine an optimum temperature and spray power by predicting food in a container based on data collected from the user cooking device. Further, the intelligent dish washing machine according to one embodiment of the present disclosure predicts the water temperature at which and oil may be decomposed at a maximum level, and the sticking degree of the food to the dish and then derives the optimal spray power based on the sticking degree.

FIG. 10 is a view for explaining an example of determining the washing state of the dish in accordance with one embodiment of the present disclosure.

Referring to FIG. 10, the processor 130 may extract feature values from the cooking information obtained from an external device to determine the washing state for the dish S131.

For example, the processor 130 may receive cooking information from at least one external device. The processor 130 may extract feature values from the cooking information. The feature value specifically represents a washing state of a dish among at least one feature that may be extracted from cooking information.

The processor 130 may apply the feature values to an artificial neural network (ANN) classifier that is trained to distinguish the washing state associated with the dish.

The processor 130 may generate a washing detection input based on the extracted feature values. The washing detection input may be input to an artificial neural network (ANN) classifier that is trained to distinguish a washing state associated with a dish based on the extracted feature value.

The processor 130 analyzes the output value of the artificial neural network S135 and determines the washing mode according to the washing state of the dish based on the output value of the artificial neural network S137.

The processor 130 may identify the washing mode according to the washing state of the dish based on the output of the artificial neural network classifier.

In one example, FIG. 10 illustrates an example in which an operation for identifying a washing mode according to a washing state of a dish using AI processing is implemented via the processing of the intelligent dish washer, but the present disclosure is not limited thereto. For example, the AI processing may be performed on the 5G network based on the cooking information received from the intelligent dish washer.

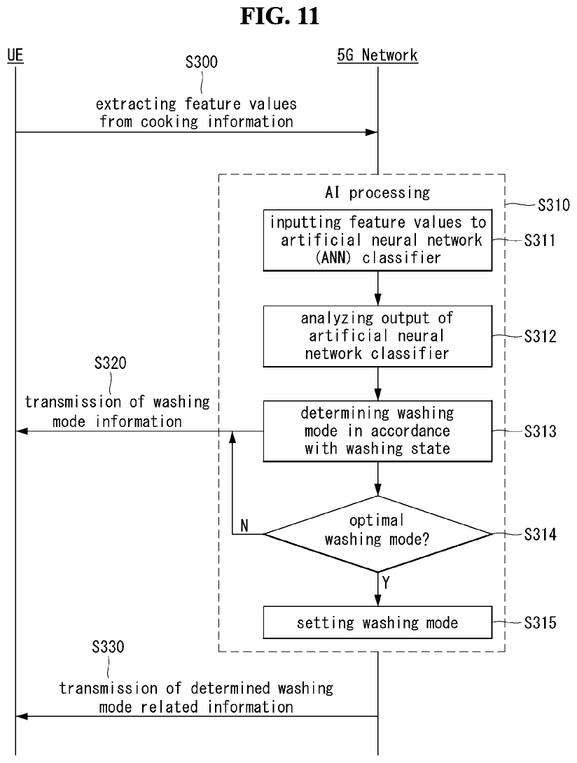

FIG. 11 illustrates another example of determining the washing state of a dish in accordance with one embodiment of the present disclosure.

The processor 130 may control the communication unit to transmit the cooking information to the AI processor included in a 5G network. Further, the processor 130 may control the communication unit to receive the AI processed information from the AI processor.

The AI processed information may be information for setting one of washing modes according to the washing state of the dish based on the cooking information.

In one example, the intelligent dish washer may perform an initial access procedure with the 5G network in order to transmit the washing state information about a dish to the 5G network. The intelligent dish washer may perform the initial access procedure with the 5G network based on the SSB (Synchronization signal block).

Further, the intelligent dish washer may receive, from the network, DCI (Downlink Control Information), which is used to schedule transmission of the cooking information obtained from the external device using a wireless communication unit.

The processor 130 may transmit the cooking information to the network based on the DCI.

The cooking information may be sent to the network on the PUSCH. The SSB and the DM-RS of the PUSCH may be quasi-co-located (QCLed) for QCL type D.

Referring to FIG. 11, the intelligent dish washer may transmit the feature values extracted from the cooking information to the 5G network S300.

In this connection, the 5G network may include the AI processor or AI system. The AI system of the 5G network may perform AI processing based on the received cooking information.

The AI system may input the feature values received from the intelligent dish washer to the ANN classifier S311. The AI system may analyze the ANN output value S312 and may determine the washing mode corresponding to the washing state for the dish based on the ANN output value S313. The 5G network may transmit the washing mode information corresponding to the washing state determined by the AI system to the intelligent dish washer using the wireless communication unit.

When determining the washing mode corresponding to the washing state for the dish S314, the AI system may set an optimal washing mode by setting one of various washing modes according to the washing state.

When the optimal washing mode corresponding to the washing state for the dish is set, the AI system may select the optimal washing mode. Further, the AI system may send information or signals related to the determined washing mode to the intelligent dish washer S330.

In one example, the intelligent dish washer sends only the cooking information to the 5G network. The intelligent dish washer may learn the washing state of the dish based on the cooking information in the AI system included in the 5G network, and extracts a feature value corresponding to a washing detection input to be used as an input to the artificial neural network for setting the washing mode based on the learned washing state.

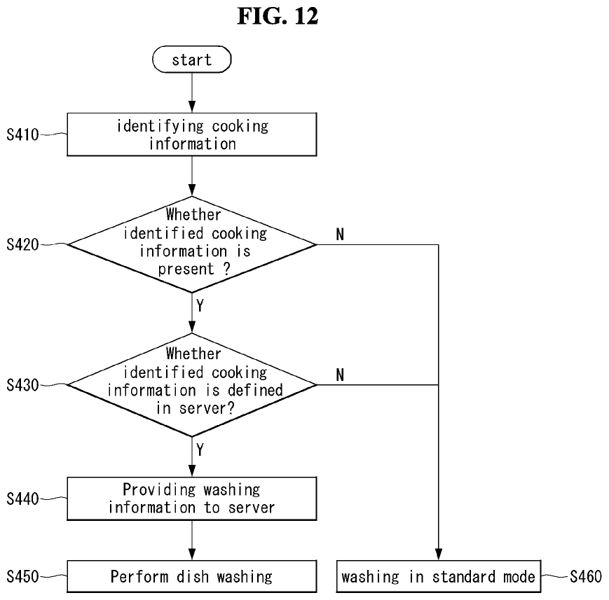

FIG. 12 is a flow chart illustrating an example of a control method of an intelligent dish washer that sets a washing mode according to one embodiment of the present disclosure.

Referring to FIG. 12, the processor may receive cooking information from an external device and identify the cooking information S410.

The processor may identify whether there is identified cooking information.

If the processor does not have identified cooking information, the processor may set the washing mode in consideration of the washing state corresponding to the dish. If the identified cooking information is present, the processor may set the standard washing mode for washing dishes. The processor may wash the dish using the set standard washing mode S460.

If the identified cooking information is present, the processor may identify whether the cooking information is the cooking information defined in the server or memory S430. For example, the defined cooking information may include first food information about the food being cooked from a cooking home device (e.g., an electric oven, microwave oven, etc.), recipe information collected based on recipes retrieved from a portable device, second food information about foods being cooked in the gas range or cooktop as collected from the camera installed in the kitchen or ventilator, cooking material information about cooking materials used for cooking among the food ingredients stored in the refrigerator, the user information, dish shape information and the like.

When the cooking information is not the cooking information defined in the server or memory, the processor may set the washing mode in consideration of the washing state of the dish corresponding thereto. When the cooking information is the cooking information defined in the server or memory, the processor may set the standard washing mode for washing dishes. The processor may wash the dish using the set standard washing mode S460.

When the cooking information is the cooking information defined in the server or memory, the process may receive washing information corresponding thereto from the server S440.

The processor may set the washing mode based on the washing information provided from the server. The processor may wash the dish using the set washing mode S450.

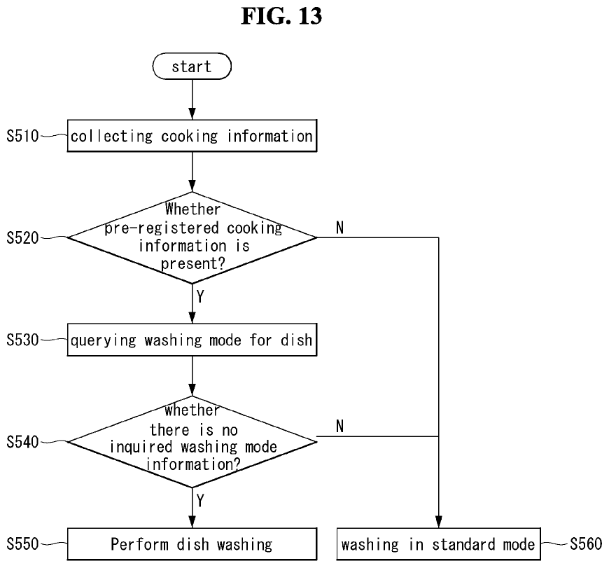

FIG. 13 is a flowchart illustrating another example of a control method of an intelligent dish washer that sets a washing mode according to one embodiment of the present disclosure.

Referring to FIG. 13, the processor may collect dish information from an external device S510. The dish information may be referred to as container information. The dish information may be collected based on the cooking information.

The processor may identify whether there is previously registered dish information S520. The processor may store the pre-used dish information on the server or in memory. The processor may set the washing mode to correspond to a general dish shape when the dish information is not registered in advance. The processor may set the washing mode to the standard washing mode when there is dish information not registered in advance. The processor may wash the unregistered dishes using the set standard washing mode S560.

When the pre-registered dish information is present, the processor may query the washing mode for the dish S530. If there is no inquired washing mode information, the processor may set the washing mode to correspond to the general dish shape. The processor may set the washing mode to the standard washing mode when there is no washing mode suitable for the dish. The processor may wash the dish without washing mode information using the standard washing mode.

When there is the washing mode information as inquired, the processor may set the washing mode suitable for the dish. The processor may wash the dish using the washing mode suitable for the dish S550.

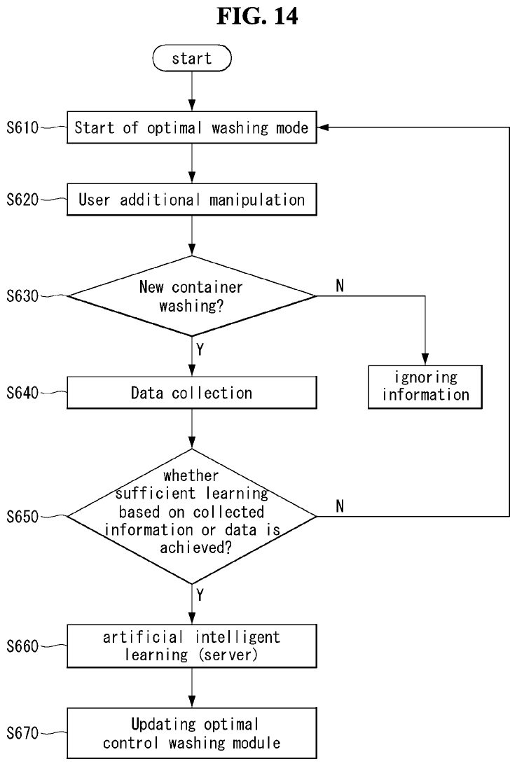

FIG. 14 is a flow chart illustrating another example of a control method of an intelligent dish washer that sets a washing mode according to one embodiment of the present disclosure.

The processor may start the optimal washing mode S610. The processor may add new manipulations desired by the user to the optimal washing mode S620. The processor may ignore information about user additional manipulation if the new manipulation as added is not directed to new dish washing 630.

The processor may collect information or data about the new dish washing S640 if the new manipulation as added is directed to the new dish washing S630. The processor may provide detailed user-specific washing functions by collecting and learning additional user manipulation information after automatic washing.

If the processor determines S650 that sufficient learning based on the collected information or data is not yet achieved, the processor may resume the optimal washing mode and continue to collect information or data.

If the processor determines S650 that sufficient learning based on the collected information or data has been achieved, the processor may perform the AI learning. AI learning may be based on a neural network model. Examples of the neural network models may include various deep learning techniques such as deep neural networks (DNN), convolutional neural networks (CNN), RNN (Recurrent Boltzmann Machine), RBM (Restricted Boltzmann Machine), DBN (deep belief networks), and deep Q-Network.

The processor may update the learned data or information using various deep learning techniques into the optimal control washing module.

As described above, the present disclosure may provide the ability to wash at optimum temperature and spray power by predicting foods in containers based on data collected from the user cooking device. Further, the present disclosure may be able to derive the optimal spraying force by predicting the water temperature at which the oil of the food on the dish is well decomposed and the sticking degree of the food.

Further, the present disclosure may be able to provide detailed user-customized washing functions by collecting and learning additional user manipulation information after automatic washing. Further, the present disclosure may provide more sophisticated user-customized washing functions by collecting and learning information about changing of the temperature or adjusting of the spray force by the user after the automatic control. Further, the present disclosure may increase the ease of use and efficiency by automatically controlling the dish washer in the home using the user context analysis.

The present disclosure described above may be implemented using a computer-readable medium with programs recorded thereon for execution by a processor to perform various methods presented herein. The computer-readable medium includes all kinds of recording devices capable of storing data that is readable by a computer system. Examples of the computer-readable mediums include hard disk drive (HDD), solid state disk (SSD), silicon disk drive (SDD), ROM, RAM, CD-ROM, a magnetic tape, a floppy disk, an optical data storage device, the other types of storage mediums presented herein, and combinations thereof. If desired, the computer-readable medium may be realized in the form of a carrier wave (e.g., transmission over Internet). Thus, the foregoing description is merely an example and is not to be considered as limiting the present disclosure. The scope of the present disclosure should be determined by rational interpretation of the appended claims, and all changes within the equivalent range of the present disclosure are included in the scope of the present disclosure.

What is claimed is:

1. An intelligent dishwasher including:
a transceiver; and
a processor coupled to the transceiver, wherein the processor is configured to:
control the transceiver to receive cooking information relating to cooking, from at least one of a plurality of external devices;
obtain dish washing information for washing a dish used for cooking based on the cooking information; and
determine a washing mode corresponding to the dish based on the dish washing information.

2. The intelligent dishwasher of claim 1, wherein the external devices include at least one of a home cooking device located in a kitchen, a mobile device for use by a user, a camera located in a kitchen, or a refrigerator.

3. The intelligent dishwasher of claim 2, wherein the cooking information includes at least one of:
first food information about food having been cooked by the home cooking device;
recipe information collected based on a recipe retrieved from the mobile device;
second food information about food having been cooked by a gas range or a cooktop and collected from the camera located in the kitchen;
cooking material information about a cooking material used for cooking among cooking materials stored in the refrigerator;
user information; or
dish shape information.

4. The intelligent dishwasher of claim 3, wherein the processor is further configured to:
obtain feature values from the cooking information;
input the feature values to an artificial neural network (ANN) classifier trained to distinguish a washing state of the dish; and
determine the washing mode further according to the washing state of the dish based on an output of the ANN.

5. The intelligent dishwasher of claim 4, wherein the feature values are used to determine the washing mode according to the washing state of the dish.

6. The intelligent dishwasher of claim 1, wherein the processor is further configured to:
control the transceiver to receive, from a network, Downlink Control Information (DCI) used to schedule transmission of the cooking information obtained from the at least one external device; and
control the transceiver to transmit the cooking information to the network based on the DCI.

7. The intelligent dishwasher of claim 6, wherein the processor is further configured to:
perform an initial connection procedure with the network based on a Synchronization signal block (SSB); and
control the transceiver to transmit the cooking information to the network on a physical uplink shared channel (PUSCH),
wherein the SSB and a demodulation reference signal (DM-RS) of the PUSCH are quasi-co-located (QCLed) for QCL type D.

8. The intelligent dishwasher of claim 7, wherein the processor is further configured to:
control the transceiver to transmit the cooking information to an artificial intelligence (AI) processor included in the network; and
control the transceiver to receive AI processed information from the AI processor,
wherein the AI processed information includes information for setting one of washing modes according to a washing state for the dish based on the cooking information.

9. The intelligent dishwasher of claim 1, wherein the obtain the dish washing information includes learning.

10. A method for controlling an intelligent dishwasher, the method including:
obtaining, via a transceiver, cooking information from at least one of a plurality of external devices;
determining a washing state of a dish based on the obtained cooking information;
setting a washing mode based on the determined washing state of the dish; and
washing the dish according to the set washing mode.

11. The method of claim 10, further comprising:
obtaining feature values from the cooking information;
inputting the feature values to an artificial neural network (ANN) classifier trained to distinguish a washing state of the dish; and
performing the determining the washing mode further in accordance with the washing state of the dish based on an output of the ANN.

12. The method of claim 11, wherein the feature values are used to determine the washing mode according to the washing state of the dish.

13. The method of claim 10, wherein the external devices include at least one of a home cooking device located in a kitchen, a mobile device for use by a user, a camera located in a kitchen, or a refrigerator.

14. The method of claim 13, wherein the cooking information includes at least one of:
first food information about food having been cooked by the home cooking device;
recipe information collected based on a recipe retrieved from the mobile device;
second food information about food having been cooked by a gas range or a cooktop and collected from the camera located in the kitchen;
cooking material information about a cooking material used for cooking among cooking materials stored in the refrigerator;
user information; or
dish shape information.

15. The method of claim 10, wherein the method further includes:
receiving, from a network, Downlink Control Information (DCI) used to schedule transmission of the cooking information obtained from the at least one external device; and
transmitting the cooking information to the network based on the DCI.

16. The method of claim 15, wherein the method further includes:
performing an initial connection procedure with the network based on a Synchronization signal block (SSB); and
transmitting the cooking information to the network on a physical uplink shared channel (PUSCH),
wherein the SSB and a demodulation reference signal (DM-RS) of the PUSCH are quasi-co-located (QCLed) for QCL type D.

17. The method of claim 16, wherein the method further includes:
controlling the transceiver to transmit the cooking information to an artificial intelligence (AI) processor included in the network; and
controlling the transceiver to receive AI processed information from the AI processor,
wherein the AI processed information includes information for setting one of washing modes according to a washing state for the dish based on the cooking information.
